(19) United States
(12) Patent Application Publication
(10) Pub. No.: US 2017/0108900 A1
(43) Pub. Date: Apr. 20, 2017

(54) VENTILATION SYSTEM AND METHOD FOR COMPUTER CASE

(71) Applicant: EVGA CORPORATION, New Taipei City (TW)

(72) Inventors: YU-CHIH CHOU, New Taipei City (TW); KUAN-HUNG CHEN, New Taipei City (TW); PEI-YU LEE, New Taipei City (TW)

(21) Appl. No.: 14/882,459

(22) Filed: Oct. 14, 2015

(51) Int. Cl. G06F 1/20

(52) U.S. Cl. CPC G06F 1/20

(57) ABSTRACT

The ventilation system for a computer case housing electronic components and cables contains a casing member, an air admission device, an air exhaust device, a first storage space, a second storage space, and a partition board. The air admission device is configured on a first side and the air exhaust device is configured on a second side of the casing member. The partition board is in the first storage space or between the first and second storage spaces. The first storage space is for the placement of the electronic components. The second storage space is for the placement of the cables. Air is drawn into the first storage space by the air admission device. Heat from the electronic components is carried by the air and expelled out of the casing member by the air exhaust device so as to achieve superior cable concealment and enhanced ventilation simultaneously.

### BACKGROUND OF THE INVENTION

(a) Technical Field of the Invention

The present invention is generally related to the computer cases, and more particular to a ventilation system and a related method for computer cases.

(b) Description of the Prior Art

Exhaust fans are usually applied to a computer case so as to draw excessive waste heat outside and to prevent the computer's electronic components from damages. However, the air drawing effect is usually limited. In addition, there are a lot of cables inside the case which is not appealing, inconvenient to maintain, and obstructive to the airflow.

### SUMMARY OF THE INVENTION

A major objective of the present invention is, by placing an air admission device and an air exhaust device at separate locations, heat from electronic components in a computer case can be expelled quickly. In addition, cables are stored exclusively in a dedicated storage space so that the inside of the case is more orderly arranged. As the cables are gathered together, replacement and maintenance is more convenient.

Another major objective of the present invention is, by having an opening on the computer case, not only electronic components can be replaced or maintained through the opening but also additional air can be drawn into the computer case to speed up ventilation.

To achieve the objectives above, the present invention teaches a ventilation system for a computer case housing electronic components and cables. The ventilation system contains a casing member, an air admission device on a first side, and an air exhaust device on a second side of the casing member. There is a first storage space for the placement of the electronic components in an air flow path between the air admission and exhaust devices. The cables are placed in a separate second storage space. A partition board is configured in the first storage space or between the first and second storage spaces. Optionally, an opening is configured on a side of the casing member connecting the first storage space to outside of the casing member. As such, air is drawn into the first storage space by the air admission device. Heat from the electronic components is carried by the air and expelled out of the casing member by the air exhaust device. The partition board provides necessary separation and the opening provides additional air intake.

Through the present invention, problems of the existing computer cases such as the inferior appeal and inconvenient maintenance from tangled cables and poor ventilation are resolved simultaneously.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a ventilation system according to an embodiment of the present invention.

FIG. 1A is a perspective diagram showing the ventilation system of FIG. 1 with a detached major side plate.

FIG. 2 is a perspective diagram showing a ventilation system according to an alternative embodiment of the present invention.

FIG. 3 is a perspective diagram showing a ventilation system according to another embodiment of the present invention.

FIG. 4 is a perspective diagram showing a ventilation system according to yet another embodiment of the present invention.

FIG. 5 is a perspective diagram showing a ventilation system according to still another embodiment of the present invention.

FIG. 6 is a perspective diagram showing a ventilation system according to yet another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

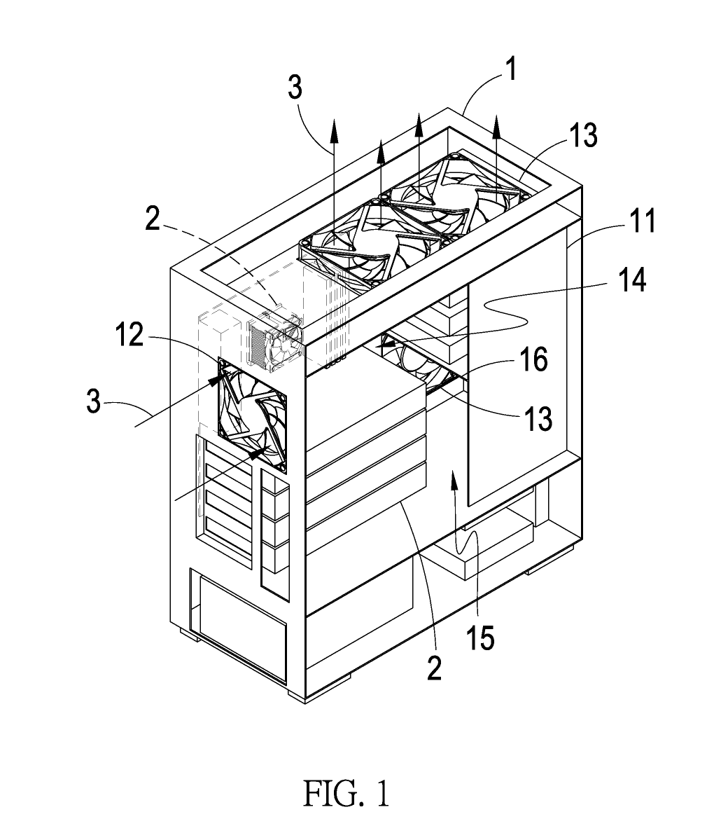

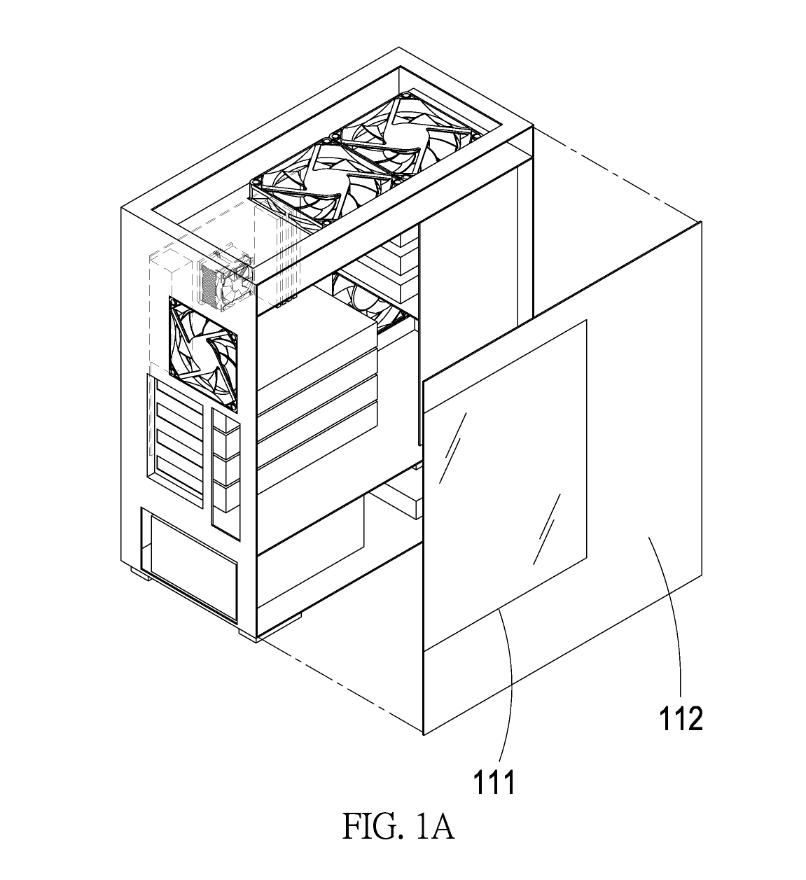

As shown in FIGS. 1 and 1A, a ventilation system according to an embodiment of the present invention contains the following components.

A casing member 1 contains a major side plate 11. The major side plate 11 contains a transparent region 111 and an opaque region 112.

At least an air admission device 12 is configured on at least a first side of the casing member 1.

At least an air exhaust device 13 is configured at least on a second side of the casing member 1 other than the first side.

At least a first storage space 14 is inside the casing member 1 between the air admission device 12 and the air exhaust device 13 for the placement of electronic components 2. The electronic components 2 contains, for example, a central processing unit (CPU), an adaptor card, a storage device, and a power supply unit (PSU). The electronic components 2 are placed in a path where air is blown by the air admission device 12.

At least a second storage space 15 is inside the casing member 1 to a side of the first storage space 14 for the placement of various cables of the electronic components 2.

At least a partition board 16 is in the first storage space 14.

As described above, the cables of the electronic components 2 are stored in the second storage space 15. Air 3 is drawn and blown into the first storage space 14 by the air admission device 12. Waste heat is then carried by the air 3 and expelled outside the casing member 1 by the air exhaust device 13. The first storage space 14 is clearly visible due to the transparent region 111 of the major side plate 11. On the other hand, the tangling cables are hidden in the second storage space 15 behind the opaque region 112 of the major side plate 11. The partition board 16 prevents the waste heat from the electronic components 2 from mixing together and divides the air 3 so as to achieve separate ventilation. A ventilation method of the present invention for a computer case where electronic components and cables are stored in a casing member contains the following steps.

Firstly, the electronic components and the cables are stored in a first storage space and a second storage space of the casing member, respectively,

Secondly, air is drawn into the first storage space through at least an air admission device on a first side of the casing member.

Thirdly, heat from the electronic components is carried by the air as the air flows past the electronic components.

Fourthly, the heat-carrying air is expelled outside the casing member by at least an air exhaust device on a second side of the casing member other than the first side.

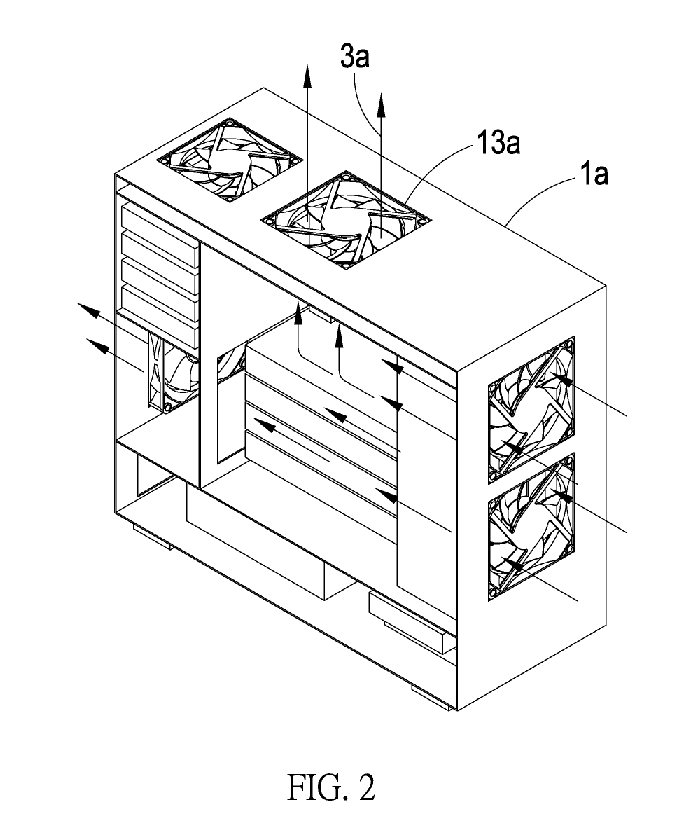

As shown in FIG. 2, there can be multiple air admission devices (not numbered) and multiple air exhaust devices 13a. Some air exhaust devices 13a are aligned with the air admission devices whereas some air exhaust devices 13a are perpendicular to the air admission devices in terms of their axial directions (i.e., the directions where air 3a are drawn by them).

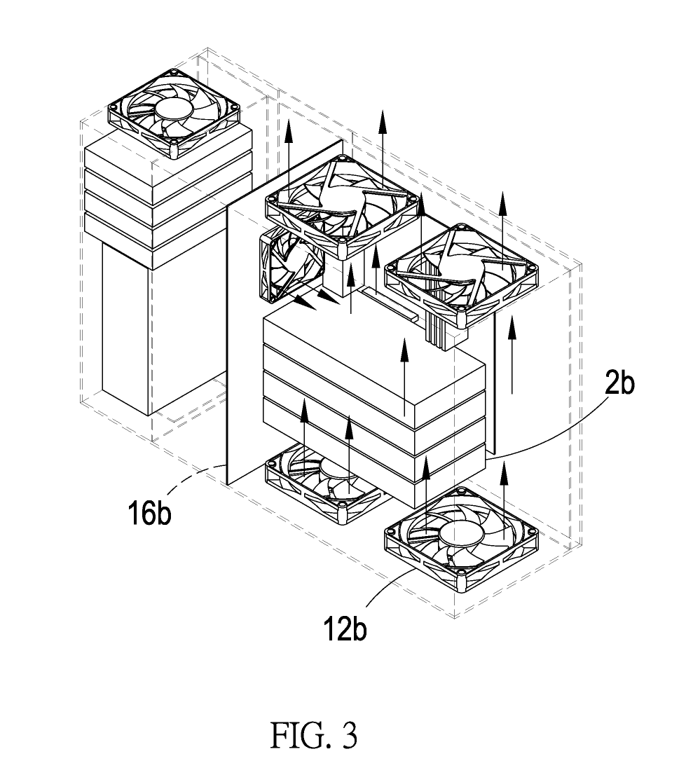

As shown in FIG. 3, another embodiment of the present invention has electronic components 2b placed blocking an aligned air flow path between air admission device 12b and some air exhaust devices (not numbered). The partition board 16b is placed between the first and second storage spaces so as to hide the cables effectively and to provide enhanced ventilation.

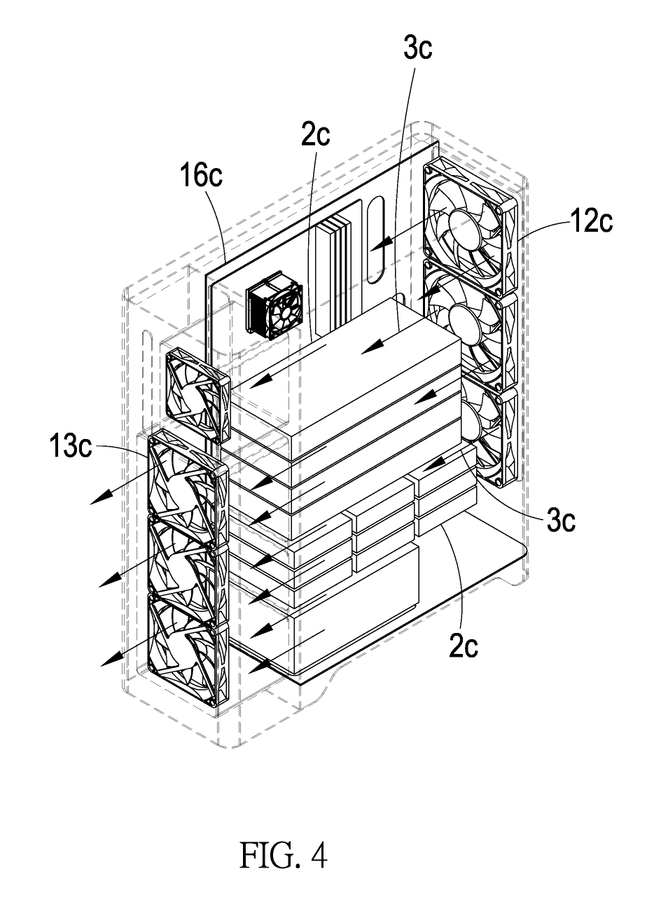

As shown in FIG. 4, yet another embodiment of the present invention has all air admission devices 12c configured oppositely to all air exhaust devices 13c. The electronic components 2c are placed so that air 3c is allowed to flow between the electronic components 2c. Moreover, the partition board 16c is placed so that a normal direction of the partition board 16c is perpendicular to a flow path of the air 3c. The partition board 16c separate the first and second storage spaces so that there is a well-defined space for cables in the second storage space and the electronic components 2c are located in the superior ventilated space.

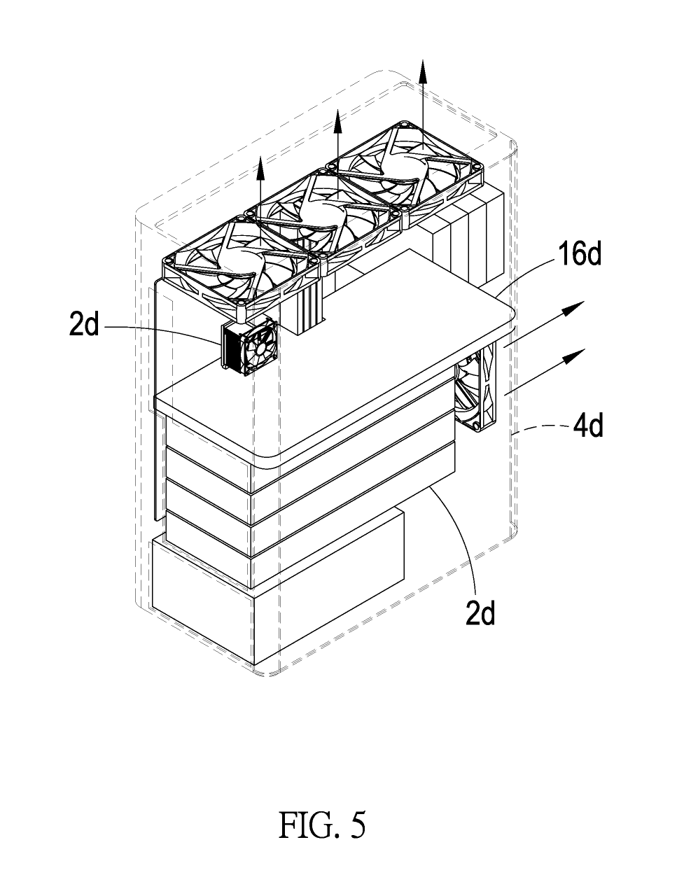

As shown in FIG. 5, still another embodiment of the present invention has a movable side plate 4d and the partition board 16d is fixedly configured on the side plate 4d. When the side plate 4d closes the casing member, the partition board 4d divides the electronic components 2d into two sets, each being in a separate space for enhanced ventilation. In the present embodiment, as shown in FIG. 5, the partition board 16d separates a CPU and the adaptor cards into two different spaces so that they are ventilated individually.

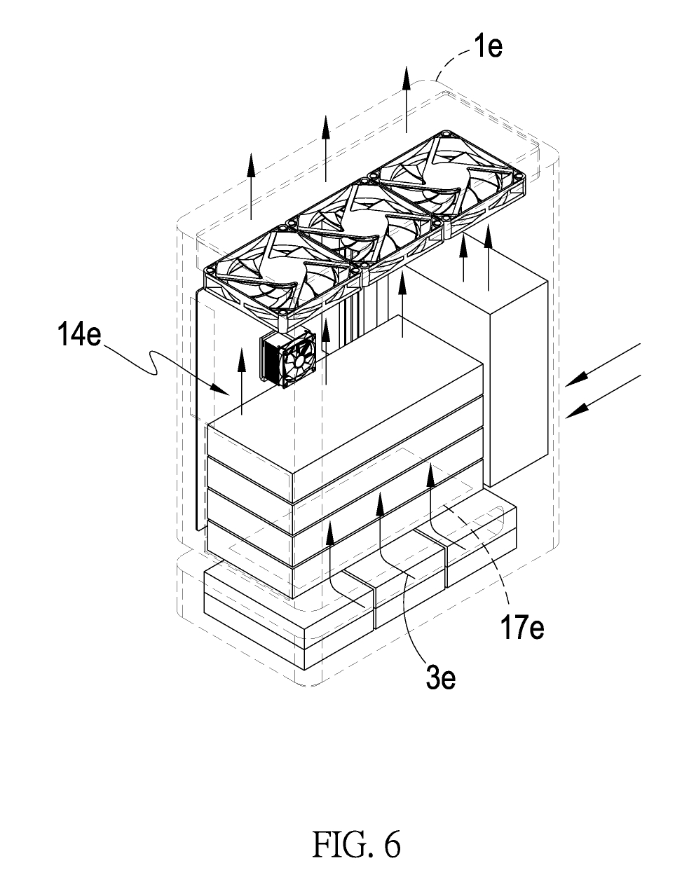

As shown in FIG. 6, yet another embodiment of the present invention has at least an opening 17e configured on a side plate connecting the first storage space 14e to outside of the casing member le. As such air 3e can also be drawn into the first storage space 14e through the opening 17e. Electronic components, if damaged, can also be replaced through the opening 17e. The opening 17e can be formed for example by punching the side plate from one side of the side plate to another side.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A ventilation system for a computer case housing a plurality of electronic components and cables comprising:
a casing member;
at least an air admission device configured on at least a first side of the casing member;
at least an air exhaust device configured on at least a second side of the casing member other than the first side;
at least a first storage space inside the casing member between the air admission and exhaust devices for the placement of the electronic components;
at least a second storage space inside the casing member for the placement of the cables; and
at least a partition board in the first storage space or between the first and second storage spaces.

2. The ventilation system according to claim 1, wherein the casing member comprises a major side plate; and the major side plate comprises a transparent region corresponding to the first storage space.

3. The ventilation system according to claim 2, wherein the major side plate further comprises an opaque region corresponding to the second storage space.

4. The ventilation system according to claim 1, wherein the electronic components comprises at least one of a central processing unit (CPU), an adaptor card, a storage device, and a power supply unit (PSU).

5. The ventilation system according to claim 1, wherein the electronic components are configured so that air is blown by the air admission device to flow between the electronic components.

6. A ventilation system for a computer case housing a plurality of electronic components and cables comprising:
a casing member;
at least an air admission device configured on at least a first side of the casing member;
at least an air exhaust device configured on at least a second side of the casing member other than the first side;
at least a first storage space inside the casing member between the air admission and exhaust devices for the placement of the electronic components;
at least a second storage space inside the casing member for the placement of the cables;
at least a partition board in the first storage space or between the first and second storage spaces; and
at least an opening configured on a side plate connecting the first storage space to outside of the casing member.

7. The ventilation system according to claim 6, wherein the opening is formed by punching the side plate from one side of the side plate to another side.

8. The ventilation system according to claim 6, wherein the casing member comprises a major side plate; and the major side plate comprises a transparent region corresponding to the first storage space.

9. The ventilation system according to claim 8, wherein the major side plate further comprises an opaque region corresponding to the second storage space.

10. The ventilation system according to claim 6, wherein the electronic components comprises at least one of a central processing unit (CPU), an adaptor card, a storage device, and a power supply unit (PSU).

11. The ventilation system according to claim 6, wherein the electronic components are configured so that air is blown by the air admission device to flow between the electronic components.

12. A ventilation method for a computer case housing a plurality of electronic components and cables in a casing member comprising the steps of:
storing the electronic components and the cables in a first storage space and a second storage space of the casing member, respectively,
drawing air into the first storage space through at least an air admission device on a side of the casing member;
carrying heat from the electronic components by the air as the air flows past the electronic components; and
expelling the heat-carrying air outside the casing member by at least an air exhaust device on a second side of the casing member other than the first side.

13. The ventilation method according to claim 12, wherein the casing member comprises a major side plate; and the major side plate comprises a transparent region corresponding to the first storage space.

14. The ventilation method according to claim 13, wherein the major side plate further comprises an opaque region corresponding to the second storage space.

15. The ventilation method according to claim 12, wherein the electronic components comprises at least one of a central processing unit (CPU), an adaptor card, a storage device, and a power supply unit (PSU).

16. The ventilation method according to claim 12, wherein the electronic components are configured so that air is blown by the air admission device to flow between the electronic components.
